(19) United States
(12) Patent Application Publication
(10) Pub. No.: US 2022/0349715 A1
(43) Pub. Date: Nov. 3, 2022

(54) VEHICLE LOCATION ANALYSIS METHOD AND NAVIGATION DEVICE

(71) Applicant: Ju Hwan PARK, Incheon (KR)

(72) Inventor: Ju Hwan PARK, Incheon (KR)

(21) Appl. No.: 17/416,059

(22) PCT Filed: Dec. 16, 2019
(86) PCT No.: PCT/KR2019/017789

§ 371 Date: Jun. 18, 2021

(30) Foreign Application Priority Data
Dec. 18, 2018 (KR) 10-2018-0164070

(51) Int. Cl. G01C 21/20; G01C 21/28

(52) U.S. Cl. CPC G01C 21/206; G01C 21/28

(57) ABSTRACT

According to an embodiment of the present invention, provided is a vehicle location analysis method for analyzing a vehicle location in a navigation device, the method including: a step for collecting travel information about a vehicle through an on-board diagnosis (OBD) scanner in the vehicle; a step for collecting topographic information about geographic features located around the vehicle; and a step for analyzing the location of the vehicle, on the basis of the travel information and topographic information, when the topographic information has been collected.

### TECHNICAL FIELD

The present invention relates to a vehicle location analysis method and a navigation device, and more particularly, to a vehicle location analysis method and a navigation device to collect terrain information on topographic features located around a vehicle and then analyze a location of the vehicle based on the terrain information and driving information of the vehicle.

### BACKGROUND ART

Since the conventional navigation using a global positioning system (GPS) obtains a GPS signal and analyzes a location of a vehicle, a reaction speed, an accuracy, and available place are limited.

In particular, the GPS cannot be used inside tunnels, undergrounds and buildings, so the location of the vehicle cannot be analyzed. Since an error range of the GPS signal reaches 15 meters to 30 meters in the outdoors where the GPS is available, the current position of the vehicle cannot be accurately measured.

Due to the above limitation of GPS, it is difficult to analyze which lane the vehicle is located in lanes divided by less than 3 meters. In addition, due to the slow reaction speed, a quick route guidance service cannot be provided in crowded alleys, highway exits, and the like.

Thus, there is an increasing demand to overcome the limitations of GPS and analyze a location of a vehicle more accurately. Accordingly, there is an urgent need for a method for solving the above-mentioned problems.

### DISCLOSURE

### Technical Problem

An objective of the present invention is to provide a vehicle location analysis method and a navigation device to collect terrain information on topographic features located around a vehicle, and then analyze a location of the vehicle based on the terrain information and driving information of the vehicle.

In addition, an objective of the present invention is to provide a vehicle location analysis method and a navigation device to use terrain information and driving information on topographic features located around a vehicle as a major factor, and analyze a location of the vehicle by using a GPS signal as an auxiliary factor when the terrain information is not collected.

Technical problems of the present invention are not limited to the above-mentioned objectives, and other objectives not mentioned herein may be apparently understood based on the following descriptions.

### Technical Solution

One embodiment of the present invention for achieving the above objectives provides a method of analyzing a location of a vehicle in a navigation device, which includes: collecting driving information of the vehicle through an on board diagnosis (OBD) scanner of the vehicle; collecting terrain information with respect to topographic features located around the vehicle; and analyzing a location of the vehicle based on the driving information and the terrain in formation, when the terrain information is collected.

The collecting of terrain information may include collecting terrain information on a feature recognized by at least one of a short-distance communication terminal, a camera, a sensor, a suspension, a black box, and a barcode reader that are mounted on the vehicle.

The analyzing of the location of the vehicle may include setting the location of the vehicle analyzed through the terrain information as a reference point, and analyzing the location of the vehicle based on the reference point a nd the driving information.

The analyzing of the location of the vehicle may include setting a location of a point selected through user input as a reference point when the terrain information is not collected, analyzing the location of the vehicle based on the reference point and the driving information.

The analyzing of the location of the vehicle may include setting the location of the vehicle analyzed through the GPS signal as a reference point when the terrain information is not collected, and analyzing the location of the vehicle based on the reference point and the driving information.

The analyzing of the location of the vehicle may include setting a location of the vehicle analyzed through the GPS signal as the reference point when the terrain information is not additionally collected while the vehicle moves more than a preset reference distance from a point corresponding to a recently collected terrain information.

The reference distance may be set based on at least one of a vehicle average speed, a driving habit, and a road condition.

The vehicle location analysis method may further include obtaining indoor map information for a building when the vehicle is detected as having entered the building based on the analyzed location of the vehicle.

The obtaining of the indoor map information may include obtaining indoor map information on a floor of the building in which the vehicle is located when the floor of the building in which the vehicle is located is confirmed based on the analyzed location of the vehicle.

Another embodiment of the present invention for achieving the above objectives provides a navigation device including: a driving information collect ion unit configured to collect driving information of a vehicle through an on board diagnosis (OBD) scanner of the vehicle; a terrain information collection u nit configured to collect terrain information on a topographic feature located a round the vehicle; and a vehicle location analysis unit configured to analyze a location of the vehicle based on the driving information and the terrain information, when the terrain information is collected.

The terrain information collection unit may collect terrain information on a feature recognized by at least one of a short-distance communication terminal, a camera, a sensor, a suspension, a black box, and a barcode reader that are mounted on the vehicle.

The vehicle location analysis unit may set the location of the vehicle analyzed through the terrain information as a reference point, and analyze the location of the vehicle based on the reference point and the driving information.

The vehicle location analysis unit may set a location of a point selected through user input as a reference point when the terrain information is not collected, analyze the location of the vehicle based on the reference point and the driving information.

The vehicle location analysis unit may set the location of the vehicle analyzed through the GPS signal as a reference point when the terrain information is not collected, and analyze the location of the vehicle based on the reference point and the driving information.

When the terrain information is not additionally collected while the vehicle moves more than a preset reference distance from a point corresponding to a recently collected terrain information, the vehicle location analysis unit may set the location of the vehicle analyzed through the GPS signal as the reference point.

The navigation device may further include a reference distance setting unit configured to set the reference distance based on at least one of a vehicle average speed, a driving habit, and a road condition.

The navigation device may further include a map information acquisition unit configured to acquire indoor map information on the building when the vehicle is detected as having entered the building based on the analyzed location of the vehicle.

When the floor of the building in which the vehicle is located is confirmed based on the analyzed location of the vehicle, the map information acquisition unit may obtain the indoor map information for the floor of the building where the vehicle is located.

### Advantageous Effects

According to one embodiment of the present invention, since the location of the vehicle may be precisely analyzed based on the terrain information and the driving information of the vehicle for the topographic feature located around the vehicle, the information on the lane where the vehicle is currently located may be accurately checked, so that a delicate navigation service can be provided.

In addition, according to one embodiment of the present invention, the terrain information and driving information of the vehicle may be utilized with respect to the topographic features located around the vehicle, so that the reaction speed can be improve to analyze the location of the vehicle, the error range can be reduced, and there is no limit of analysis areas indoors and outdoors.

In addition, according to one embodiment of the present invention, the location of the vehicle may be analyzed by collecting terrain information about the previously installed topographic features such as devices including road bumps, lanes, or parking lot entrance blockers, the location of the corresponding vehicle may be analyzed by collecting terrain information on the corresponding point simply by installing the features at a specific points, so that the convenience can be increased without additional infrastructure facilities.

In addition, according to one embodiment of the present invention, the location of the vehicle may be analyzed based on the terrain information and driving information collected only for a predetermined period from the collection of the terrain information, the location of the vehicle may be analyzed based on the GPS signal and driving information when additional terrain information is not collected after the vehicle has moved more than a predetermined distance, so that an occurrence of an error, which is increased as the distance between the vehicle and the point corresponding to the terrain information is increased, can be prevented in advance.

In addition, according to one embodiment of the present invention, the location of the vehicle may be precisely analyzed based on the terrain information and the driving information of the vehicle for the topographic feature located around the vehicle, so that not only the building in which the vehicle is located, but also the floor of the building may be analyzed regardless of the location of the vehicle even when the vehicle is located inside the building, and the accurate indoor location of the moving vehicle may also be analyzed, and thus a precise navigation service can be provided.

The advantageous effect of the present invention is not limited to the above effects, and it may be understood to include all effects that can be inferred from the construction of the invention described in the detailed description or claims of the present invention.

### DESCRIPTION OF DRAWINGS

FIG. 1 is a diagram showing a vehicle location analysis system according to one embodiment of the present invention.

FIG. 2 is a block diagram showing a configuration of a navigation device according to one embodiment of the present invention.

FIG. 3 is a diagram showing a process of analyzing a location of a vehicle equipped with the navigation device according to one embodiment of the present invention.

FIG. 4 is a diagram showing information on vehicles located outdoors and map information around the vehicles according to one embodiment of the present invention.

FIG. 5 is a diagram showing information on a vehicle located indoors and map information around the vehicle according to one embodiment of the present invention.

### BEST MODE

### Mode for Invention

Hereinafter, the present invention will be described in detail with reference to the accompanying drawings. However, the present invention may be embodied in various different forms and accordingly, is not limited to the embodiments described herein. In addition, parts irrelevant to the description are omitted in the drawings to clearly describe the present invention, and like reference numerals designate like parts throughout the specification.

Throughout the specification, when a part is “connected” the other part, the above expression includes not only “being directly connected” but also “being indirectly connected” with another member interposed therebetween. In addition, when a part “includes” a certain component, the above expression does not exclude other components, but may further include the other components, unless particularly stated otherwise.

Hereinafter, the embodiments of the present invention will be described in detail with reference to the accompanying drawings.

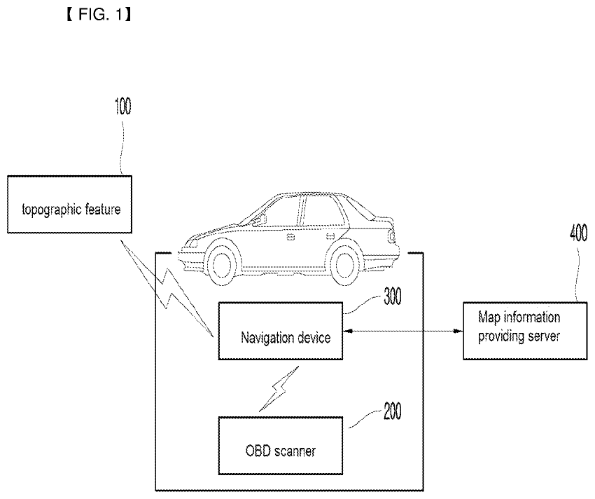

FIG. 1 is a diagram showing a vehicle location analysis system according to one embodiment of the present invention.

Referring to FIG. 1, the vehicle location analysis system according to one embodiment of the present invention may include topographic features 100 capable of communicating with each other through wireless communication or communication network, an OBD scanner 200, a navigation device 300, and a map information providing server 400.

First, the topographic features 100 refers to all objects on the ground, particularly, refers to objects that can be recognized through an identification device mounted on a vehicle, and may be located on the road, or may be located on peripheries of the road.

For example, the topographic features 100 may include devices previously installed at specific points, such as road bumps, lanes, and parking entrance barriers, and may also include devices newly installed at specific points to provide services such as short-distance communication terminals, barcodes, and QR codes.

The topographic features 100 may be recognized through an identification device such as a short-distance communication terminal, a camera, a sensor, a suspension, a black box, and a barcode reader mounted on a vehicle.

The OBD scanner 200 may generate driving information on a vehicle equipped with the OBD scanner 200. For example, the OBD scanner 200 may analyze the steering wheel angle, driving speed, gear shift, and the like in real time, so that driving information indicating the moving direction, moving speed, and moving distance of the vehicle may be generated.

The OBD scanner 200 may transmit the driving information generated in real time to the navigation device 300 by using wired or wireless communication through an OBD terminal of the vehicle.

The navigation device 300 may check a current location of the vehicle equipped with the navigation device 300 to display the current location of the vehicle and map information around the vehicle on a screen.

The navigation device 300 may receive and collect vehicle the driving information from the OBD scanner 200 in real time.

For example, the navigation device 300 may receive information on vehicle speed, direction, brake, gear, and the like through the OBD scanner 200, and collect the driving information on the vehicle.

The navigation device 300 may collect terrain information on the topographic features 100 located around the vehicle.

For example, the navigation device 300 may recognize the topographic features 100 through the identification device, such as short-distance communication terminal, camera, sensor, suspension, black box, and barcode reader, mounted on the vehicle, and then collect terrain information on the recognized topographic features 100.

The navigation device 300 may analyze points installed with the topographic features 100 and a current location of the vehicle based on the terrain information.

For example, the identification device such as short-distance communication terminal, camera, sensor, suspension, black box, and barcode reader mounted on the vehicle may identify and recognize the topographic features 100 such as road barriers, lanes, and parking entrance blockers that are previously installed at specific points, or may identify and recognize the topographic features 100 such as short-distance communication terminals, barcodes, and QR codes that are newly installed at specific points. The navigation device 300 may analyze the terrain information about the topographic features 100 recognized through the identification device to recognize the accurate points in which topographic features 100 are installed and the current location of the vehicle.

When the terrain information is collected, the navigation device 300 may analyze and confirm the location of the vehicle based on the driving information and the terrain information.

Specifically, the navigation device 300 may analyze the current location of the vehicle through the terrain information, set the analyzed location of the vehicle as a reference point, and update and analyze locations of the moving vehicle based on the reference point and the driving information.

For example, the navigation device 300 may set the location of the vehicle analyzed through the terrain information as a reference point, analyze locations of the moving vehicle based on the driving information (such as a moving direction from the reference point, a moving speed, and a moving distance) analyzed through the OBD scanner 200, and display the locations on the map.

The map information providing server 400 may store and manage map information in a database, and store and manage not only outdoor map information but also indoor map information of buildings.

The map information providing server 400 may transmit the map information to the navigation device 300, and transmit map information around the vehicle to the navigation device 300 in real time or periodically according to the current location of the vehicle.

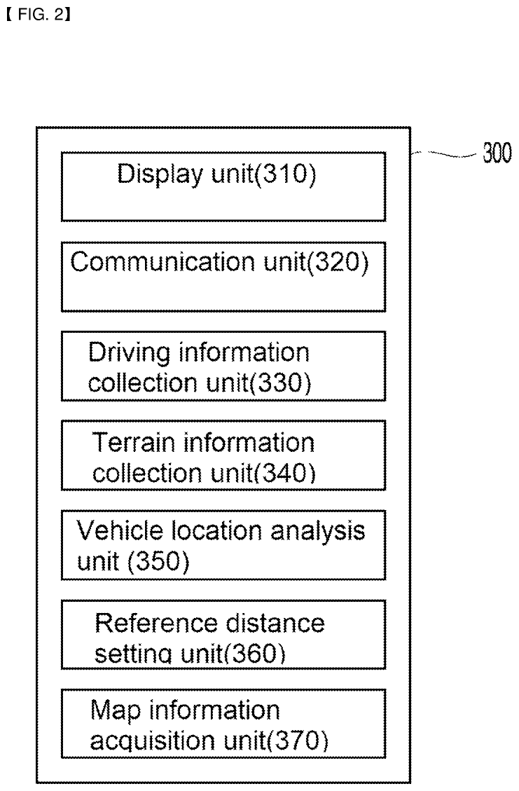

FIG. 2 is a block diagram showing the configuration of the navigation device 300 according to one embodiment of the present invention.

Referring to FIG. 2, the navigation device 300 may include a display unit 310, a communication unit 320, a driving information collection unit 330, a terrain information collection unit 340, a vehicle location analysis unit 350, a reference distance setting unit 360, and a map information acquisition unit 370.

The navigation device 300 includes a basic components required to provide a navigation service, and may include, for example, an input/output interface, a memory, a processor, and the like.

The display unit 310 may display the current location of the vehicle in which the navigation device 300 is mounted and the map information about the location of the vehicle on the screen.

Specifically, the display unit 310 may display the current location of the vehicle and the map information around the vehicle on the screen, based on the location of the vehicle analyzed by the vehicle location analysis unit 350 described later.

The communication unit 320 may be connected to an external device through wired or wireless communication to transmit or receive information with the external device through the communication.

Specifically, the communication unit 320 may receive the driving information of the vehicle from the OBD scanner 200 when the vehicle equipped with the navigation device 300 moves, and receive identification information broadcasting from the topographic features 100 and implemented by a short-range communication terminal.

The communication unit 320 may include a communication module for performing wired communication or wireless communication, and may further include a GPS module for obtaining a GPS signal.

When the navigation device 300 is actuated, the communication unit 320 may be controlled to obtain the GPS signal through the GPS module.

The driving information collection unit 330 may receive and collect driving information of the vehicle through the OBD scanner 200.

For example, the driving information collection unit 330 may receive information on vehicle speed, direction, brake, gear, and the like through the OBD scanner 200 to collect the driving information of the vehicle.

The terrain information collection unit 340 may collect terrain information on the topographic features 100 located around the vehicle.

Specifically, the terrain information collection unit 340 may recognize the topographic features 100 through at least one of the short-distance communication terminal, the camera, the sensor, the suspension, the black box, and the barcode reader that are mounted on the vehicle, and then may collect terrain information on the recognized topographic features 100.

According to one embodiment, the topographic features 100 implemented by the short-distance communication terminal may be installed at an underground parking entrance, a lane, a stop line, a toll gate or the like. When identification information is transmitted from the topographic features 100 located around the vehicle to the communication unit 320 and the topographic features 100 are recognized, the terrain information collection unit 340 may identify points in which the topographic features 100 are installed through the identification information to generate and collect terrain information about the topographic features 100.

According to another embodiment, when the topographic features 100 are installed in the form of road bumps, lanes, parking entrance blockers, or the like, and the features 100 are recognized from image information photographed by the camera mounted on the vehicle, the terrain information indicating accurate points in which the recognized topographic features 100 are installed may be generated and collected.

In the terrain information collection unit 340 as described above, the terrain information about the topographic features 100 may be collected through the short-distance communication terminal, camera, sensor, suspension, black box and barcode reader mounted on the vehicle, in other words, the terrain information on the topographic features 100 located around the vehicle may be collected through various devices mounted on the vehicle.

In the process of collecting the geographic information, the terrain information collection unit 340 may collect the terrain information by identifying the points installed with the topographic features 100 based on the map information stored in the memory of the navigation device 300, or may collect the terrain information by identifying the points installed with the topographic features 100 based on map information received from the map information providing server 400.

When the terrain information is collected in the terrain information collection unit 340, the vehicle location analysis unit 350 may analyze the location of the vehicle based on the driving information and the terrain information.

The vehicle location analysis unit 350 may analyze the current location of the vehicle through the terrain information, set the analyzed location of the vehicle as a reference point, and update and analyze the location of the moving vehicle based on the reference point and the driving information.

When the terrain information is not collected, the vehicle location analysis unit 350 may set a location of a point selected through user input as a reference point and update and analyze the location of the moving vehicle based on the reference point and the driving information.

When the terrain information is not collected, the vehicle location analysis unit 350 may analyze the current location of the vehicle through the GPS signal obtained from the communication unit 320, set the analyzed location of the vehicle as a reference point, and update and analyze the location of the moving vehicle based on the reference point and the driving information.

When the reference point is set, the vehicle location analysis unit 350 may set the reference point according to a predetermined priority, and may set the reference point according to the priority in which the location of the vehicle analyzed through the terrain information may be set as a first priority, the location of the point selected through the user input may be set as a second priority, and the location of the vehicle analyzed through the GPS signal as a third priority.

Upon setting the reference point of the first priority, when the terrain information is collected through the identification device mounted on the vehicle, the vehicle location analysis unit 350 may analyze the location of the vehicle through the terrain information, and set the analyzed current location of the vehicle as the reference point within a narrow error range.

Upon setting the reference point of the second priority, the vehicle location analysis unit 350 may analyze the location of the point directly inputted by the user (for example, spot C-1 of parking lot B of apartment A), and set the analyzed current location of the vehicle as the reference point within an intermediate error range.

Upon setting the reference point of the third priority, the vehicle location analysis unit 350 may analyzed the location of the vehicle analyzed through the GPS signal, and set the analyzed current location of the vehicle as the reference point within a wide error range.

In addition, upon setting the reference point of the third priority, the vehicle location analysis unit 350 may analyze the current location of the vehicle through the driving information, the map information, and the GPS signal, and then set a reference point when determining that the location is significantly reliable, and may periodically update the current location of the vehicle to reset the reference point whenever the error is accumulated because the error range increases depending on the weather, tire conditions, road conditions, driving habits, driving distance, or the like.

As described above, the vehicle location analysis unit 350 may set the current location of the vehicle as the reference point based on the priority. When the reference point is not set in a specific priority, the reference point may be alternatively set by posterior priority.

In other words, the vehicle location analysis unit 350 may set the reference point in the order of higher reliability according to a narrower error range to analyze the location of the vehicle with a narrow error range, even to areas where GPS signals are not received, and may analyze the location of the vehicle in all areas to which the vehicle can move, such as inside the underground parking lot, in conjunction with map information.

The vehicle location analysis unit 350 may set the reference point according to the priority, and update and analyze the location of the vehicle in real time based on the set reference point and the driving information. For example, the current location of the vehicle may be updated in real time from the map information by analyzing driving information collected until stopping after going straight 300 meters from the reference point, turning right, and going straight 100 meters.

The vehicle location analysis unit 350 may analyze the location of the vehicle based on the recently collected terrain information and driving information. When another terrain information is additionally collected, the location of the vehicle may be analyzed based on the newly collected terrain information and driving information.

For example, when the vehicle location analysis unit 350 collects first terrain information, the vehicle location analysis unit 350 may set the location of the vehicle analyzed through the first terrain information as a reference point, and analyze the location of the vehicle based on the set reference point and the driving information. In the meantime, when second terrain information is additionally collected after the first terrain information is collected, the vehicle location analysis unit 350 may set the location of the vehicle analyzed through the second terrain information as a reference point, and analyze the location of the vehicle based on the set reference point and the driving information.

When the vehicle moves to a preset reference distance or farther from a point corresponding to the recently collected terrain information, and additional terrain information is not collected, the vehicle location analysis unit 350 may set the reference point in the order of second or third priority, and analyze the location of the vehicle based on the set reference point and the driving information.

For example, in a state that the vehicle has moved to the preset reference distance or farther from the point corresponding to the recently collected terrain information while analyzing the location of the vehicle based on the recently collected terrain information and driving information, the vehicle location analysis unit 350 may ignore the recently collected terrain information when another terrain information is not newly collected, set the location of the vehicle analyzed through the GPS signal as a reference point, and analyze the location of the vehicle based on the set reference point and the driving information.

The vehicle location analysis unit 350 may detect whether the vehicle enter a building by analyzing the location of the vehicle, and may also confirm the floor of the building in which the vehicle is located, through the analyzed location of the vehicle.

The reference distance setting unit 360 may set the reference distance based on at least one of an average speed of the vehicle equipped with the navigation device 300, a driving habit, and a current road condition.

The reference distance setting unit 360 may set the reference distance again by checking at least one of the average speed of the vehicle, the driving habits and the road condition in real time or periodically.

For example, the reference distance setting unit 360 may be set to increase the reference distance as the average speed of the vehicle is increased, or the current driving road condition is closer to an unpaved road.

After the reference distance is set in the reference distance setting unit 360, and when additional terrain information is not collected as the vehicle moves to a preset reference distance or farther from a point corresponding to the terrain information collected by the terrain information collection unit 340, the vehicle location analysis unit 350 may analyze the current location of the vehicle through the GPS signal obtained from the communication unit 320, and set the analyzed location of the vehicle as a reference point.

For example, when the reference distance is set to 500 meters in the reference distance setting unit 360, and when the vehicle moves more than 500 meters from the point corresponding to the first terrain information, and the second terrain information is not additionally collected in a state that the vehicle location analysis unit 350 is analyzing the location of the vehicle after setting the location of the vehicle analyzed through the first terrain information as the reference point, the vehicle location analysis unit 350 may set to change the location of the vehicle analyzed through the GPS signal as the reference point.

The map information acquisition unit 370 may obtain the surrounding map information of the vehicle according to the current location of the vehicle, from the memory of the navigation device 300 or the map information providing server 400, and the display unit 310 may display the map information obtained by the map information acquisition unit 370 on the screen.

When it is detected that the vehicle has entered the building based on the location of the vehicle analyzed by the vehicle location analysis unit 350, the map information acquisition unit 370 may obtain indoor map information about the building.

Before the vehicle enters the building, the map information acquisition unit 370 may acquire the indoor map information about the building from the memory of the navigation device 300 or the map information providing server 400.

When the indoor map information about the building is not stored in the memory of the navigation device 300, the map information acquisition unit 370 may receive and download the indoor map information about the building from the map information providing server 400.

When the floor of the building where the vehicle is located is confirmed based on the location of the vehicle analyzed by the vehicle location analysis unit 350, the map information acquisition unit 370 may obtain the indoor map information for the floor of the building where the vehicle is located.

For example, the map information acquisition unit 370 may obtain map information for the first basement floor of the building when the vehicle enters the first basement floor of the building, and may obtain map information for the second basement floor of the building when the vehicle enters the second basement floor of the building.

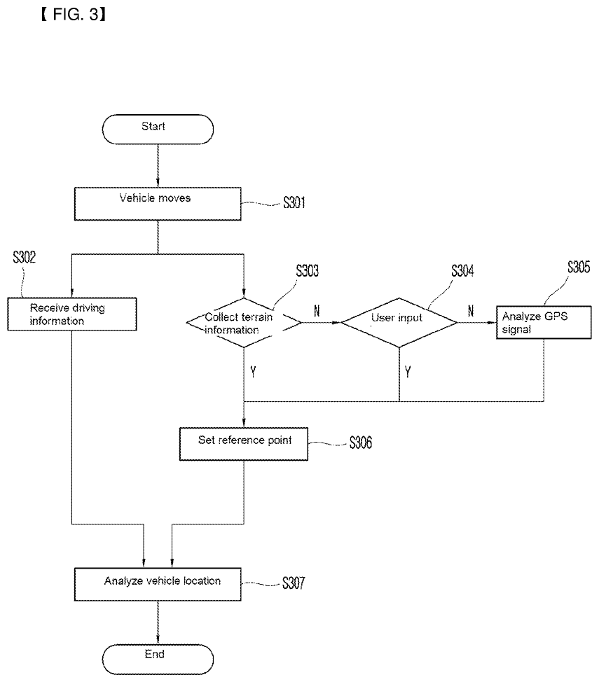

FIG. 3 is a diagram showing a process of analyzing the location of the vehicle equipped with the navigation device 300 according to one embodiment of the present invention.

First, when the vehicle equipped with the navigation device 300 is ignited, the navigation device 300 may be actuated, and the OBD scanner 200 of the vehicle may also be actuated.

Then, when the vehicle moves in vehicle moving step S301, the navigation device 300 in driving information collection step S302 may collect vehicle driving information through the OBD scanner 200, and may collect terrain information on the topographic features 100 located around the vehicle in terrain information collection step S303.

According to one embodiment, the navigation device 300 may obtain a GPS signal as soon as the vehicle is ignited and the navigation device 300 and the OBD scanner 200 are actuated, the OBD scanner 200 may measure driving information and transmit the driving information to the navigation device 300, the navigation device 300 may obtain the GPS signal varying according to the movement of the vehicle in real time or periodically, and the OBD scanner 200 may transmit the driving information newly generated according to the movement of the vehicle to the navigation device 300.

The navigation device 300 may maintain a standby state to collect terrain information while collecting the driving information when the vehicle moves. When the terrain information is collected in step S303, the navigation device 300, in reference point setting step S306, may set the location of the vehicle analyzed through the terrain information as the reference point.

When the terrain information is not collected in step S303, the navigation device 300 may be switched to a standby state for user input, and when a specific point is selected through the user input in the user input step S304, the navigation device 300, in step S306, may set a location of the point selected through the user input as the reference point.

In step S304, when the specific point is not selected through the user input, the navigation device 300, in GPS signal analysis step S305, may analyze the location of the vehicle through the GPS signal that is being obtained, and may, in step S306, set the location of the vehicle analyzed through the GPS signal as the reference point.

In other words, the navigation device 300 may set the reference point by setting the location of the vehicle analyzed through the terrain information as a first priority. When the reference point is not set as the first priority, the reference point may be set by placing the location of the point selected through the user input as a second priority. When the reference point is not set as the second priority, the reference point may be set by placing the location of the vehicle analyzed through the GPS signal as a third priority.

In vehicle location analysis step S307, the navigation device 300 may analyze the location of the vehicle based on the driving information collected in step S302 and the reference point set in step S306.

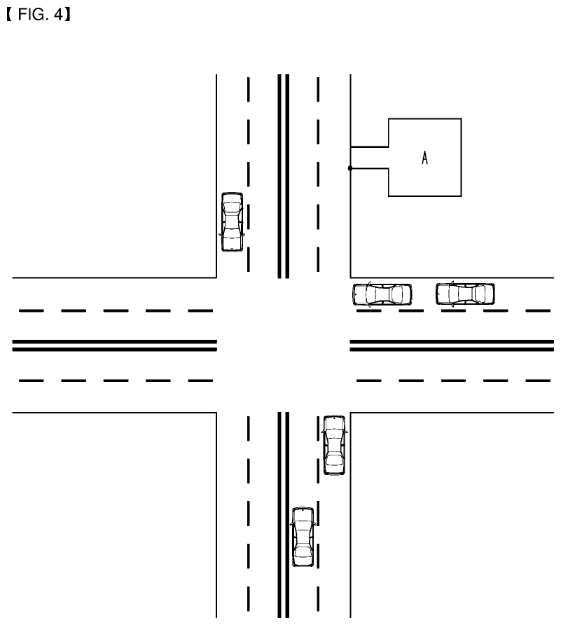

FIG. 4 is a diagram showing information on vehicles located outdoors and map information around the vehicles according to one embodiment of the present invention.

First, when the vehicle equipped with the navigation device 300 is located outdoors, the navigation device 300 may receive the driving information from the OBD scanner 200 while obtaining the GPS signal, set the location of the vehicle analyzed through the GPS signal as a reference point, analyze the location of the vehicle based on the set reference point and the driving information.

According to one embodiment, the topographic features 100 may include lanes, stop lines, toll gates, intersections, and the like that are installed outdoors. The navigation device 300 may recognize and collect terrain information on the topographic features 100 installed outdoors.

For example, when the topographic feature 100 is installed in the first lane, and when the topographic feature 100 is recognized through at least one of a short-distance communication terminal, a camera, a sensor, a suspension, a black box, and a barcode reader that are mounted on the vehicle, the navigation device 300 may collect terrain information indicating the width of lanes, the number of lanes, and the like.

According to another embodiment, the topographic feature 100 may be embodied as a structure, a signboard or the like installed in a lane, a stop line, a toll gate, an intersection or the like of a specific place. The navigation device 300 may check the surrounding image information of the vehicle photographed by the camera mounted on the vehicle, may collect terrain information on the recognized topographic features 100 when the topographic feature 100 is recognized from the image information.

For example, when a traffic light is placed at the intersection, the navigation device 300 may recognize the traffic light from the surrounding image information of the vehicle photographed by the camera mounted on the vehicle, and collect terrain information about the intersection in which the traffic light is placed.

In other words, the navigation device 300 may collect the terrain information about the topographic features 100 located around the vehicle, set the location of the vehicle analyzed through the collected terrain information as the reference point, and analyze the location of the vehicle based on the set reference point and the driving information, so that the location of the vehicle may be precisely analyzed within an error range of the GPS signal.

When the terrain information is not additionally collected for a preset period, and when additional terrain information is not collected though the vehicle has moved more than the preset reference distance from the point corresponding to the recently collected terrain information, the navigation device 300 may set a reference point by using the GPS signal being obtained, and analyze the location of the vehicle based on the set reference point and the driving information.

For example, when no terrain information is additionally collected even though the vehicle has moved 500 meters for 3 minutes after the terrain information about the intersection has been collected, the navigation device 300 may set the location of the vehicle analyzed through the GPS signal as a reference point, analyze the location of the vehicle based on the set reference point and the driving information.

In other words, when collecting the terrain information on the topographic features 100 located around the vehicle equipped with the navigation device 300, the navigation device 300 may set the location of the vehicle analyzed through the collected terrain information as the reference point, and analyze the location of the vehicle. As a distance between the vehicle and the point corresponding to the recently collected terrain information is increased, an error in analyzing the location of the vehicle based on the terrain information may be increased. Accordingly, when additional terrain information is not collected even though the vehicle has moved more than a predetermined distance, the navigation device 300 may ignore the recently collected terrain information, set the location of the vehicle analyzed through the GPS signal as a reference point, analyze the location of the vehicle.

The navigation device 300 may analyze the location of the vehicle to detect that the vehicle enters the building based on the analyzed location. For example, when the vehicle moves in the direction of an entrance of building A shown in FIG. 4, the navigation device 300 may detect that the vehicle has entered the inside of building A.

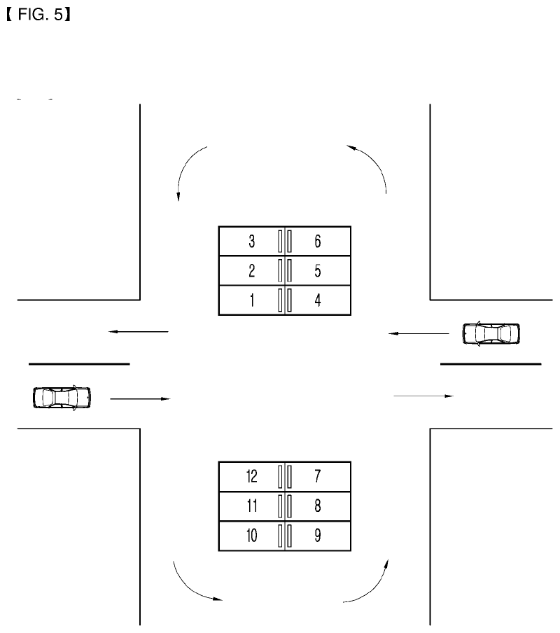

FIG. 5 is a diagram showing information on a vehicle located indoors and map information around the vehicle according to one embodiment of the present invention.

First, when the terrain information is collected, the navigation device 300 may analyze the location of the vehicle based on the terrain information and driving information, and detect that the vehicle has entered the building based on the analyzed location of the vehicle.

For example, when the topographic feature 100 implemented as a short-distance communication terminal is installed at the entrance of the building parking lot, the navigation device 300 may collect terrain information about the entrance to the building parking lot through identification information received from the topographic feature 100.

In addition, when the topographic feature 100 embodied as a structure is disposed at the entrance of the building parking lot, and when the navigation device 300 recognizes the topographic feature 100 by checking the surrounding image information of the vehicle photographed by the camera mounted on the vehicle, the navigation device 300 may collect terrain information about the entrance to the building parking lot where the structure is disposed.

When the vehicle is expected to enter the building based on the collection of terrain information, and before the vehicle enters the building, the navigation device 300 may previously obtain indoor map information for a building which the vehicle will enter.

For example, the navigation device 300 may obtain the indoor map information for building A from the memory of the navigation device 300. When the indoor map information for the building A is not stored in the memory of the navigation device 300, the indoor map information for the building A may be obtained from the map information providing server 400.

The navigation device 300 may check the floor of the building in which the vehicle moves, based on the collection of the terrain information, and obtain the indoor map information for the floor of the building where the vehicle is located.

For example, when the entrance of the underground parking lot is connected to the first basement floor, the navigation device 300 may obtain indoor map information for the first basement floor of the building when collecting terrain information about the entrance of the underground parking lot, and may obtain Indoor map information for the second basement floor of the building when terrain information about an entrance connected from the first basement floor to the second basement floor is collected.

When the vehicle enters the building, the navigation device 300 may analyze the location of the vehicle based on the terrain information and driving information.

For example, when the vehicle enters the first basement floor and moves to a sixth district through the entrance, the navigation device 300 may analyze the location of the vehicle by collecting terrain information about the entrance to the first basement floor, and analyze the location of the vehicle moving to the sixth district by analyzing the driving information of the vehicle in real time.

The navigation device 300 may analyze the location of the vehicle based on the terrain information and driving information even when the GPS signal is not obtained inside the building, and may check various information on the width of lanes and the number of lanes even in the building underground parking lot since terrain information may be collected about a topographic feature 100 installed in a specific area of the building underground parking lot.

Thus, according to one embodiment of the present invention, since the location of the vehicle may be precisely analyzed based on the terrain information and the driving information of the vehicle for the topographic feature 100 located around the vehicle, the information on the lane where the vehicle is currently located may be accurately checked, so that a delicate navigation service can be provided.

In addition, according to one embodiment of the present invention, the terrain information and driving information of the vehicle may be utilized with respect to the topographic features 100 located around the vehicle, so that the reaction speed can be improve to analyze the location of the vehicle, the error range can be reduced, and there is no limit of analysis areas indoors and outdoors.

In addition, according to one embodiment of the present invention, the location of the vehicle may be analyzed by collecting terrain information about the previously installed topographic features 100 such as devices including road bumps, lanes, or parking lot entrance blockers, and the location of the vehicle may be analyzed by collecting terrain information about the corresponding points by simply installing the features 100 at a specific points, so that the convenience can be increased without additional infrastructure facilities.

In addition, according to one embodiment of the present invention, the location of the vehicle may be analyzed based on the terrain information and driving information collected only for a predetermined period from the collection of the terrain information, and the location of the vehicle may be analyzed based on the GPS signal and driving information when additional terrain information is not collected after the vehicle has moved more than a predetermined distance, so that an occurrence of an error, which is increased as the distance between the vehicle and the point corresponding to the terrain information is increased, can be prevented in advance.

In addition, according to one embodiment of the present invention, the location of the vehicle may be precisely analyzed based on the terrain information and the driving information of the vehicle for the topographic feature 100 located around the vehicle, not only the building in which the vehicle is located, but also the floor of the building may be analyzed regardless of the location of the vehicle even when the vehicle is located inside the building, and the accurate indoor location of the moving vehicle may also be analyzed, so that a precise navigation service can be provided.

The above description of the present invention is merely for illustration, and it will be apparent that a person having ordinary skill in the art may carry out various deformations and modifications within the scope without departing from the idea of the present invention, the following claims and equivalents thereof. Therefore, the above described embodiments should be understood in all respects as illustrative and not restrictive. For example, each component described as unitary may be implemented in a distributed manner. Likewise, components that are described as distributed may also be implemented in a combined form.

The scope of the invention is indicated by the following claims, and all deformations or modifications derived from the idea and scope of the claims and their equivalents should be construed as being included in the scope of the present invention.

1. A method of analyzing a location of a vehicle in a navigation device, the vehicle location analysis method comprising:
collecting driving information of the vehicle through an on board diagnosis (OBD) scanner of the vehicle;
collecting terrain information with respect to topographic features located around the vehicle; and
analyzing a location of the vehicle based on the driving information and the terrain information, when the terrain information is collected.

2. The vehicle location analysis method of claim 1, wherein the collecting of terrain information includes:
collecting terrain information on a feature recognized by at least one of a short-distance communication terminal, a camera, a sensor, a suspension, a black box, and a barcode reader that are mounted on the vehicle.

3. The vehicle location analysis method of claim 1, wherein the analyzing of the location of the vehicle includes:
setting the location of the vehicle analyzed through the terrain information as a reference point; and
analyzing the location of the vehicle based on the reference point and the driving information.

4. The vehicle location analysis method of claim 3, wherein the analyzing of the location of the vehicle includes:
setting a location of a point selected through user input as a reference point when the terrain information is not collected, and
analyzing the location of the vehicle based on the reference point and the driving information.

5. The vehicle location analysis method of claim 3, wherein the analyzing of the location of the vehicle includes:
setting the location of the vehicle analyzed through the GPS signal as a reference point when the terrain information is not collected; and
analyzing the location of the vehicle based on the reference point and the driving information.

6. The vehicle location analysis method of claim 5, wherein the analyzing of the location of the vehicle includes:
setting a location of the vehicle analyzed through the GPS signal as the reference point, when the terrain information is not additionally collected while the vehicle moves more than a preset reference distance from a point corresponding to a recently collected terrain information.

7. The vehicle location analysis method of claim 6, wherein the reference distance is set based on at least one of a vehicle average speed, a driving habit, and a road condition.

8. The vehicle location analysis method of claim 1, further comprising:
obtaining indoor map information for a building when the vehicle is detected as having entered the building based on the analyzed location of the vehicle.

9. The vehicle location analysis method of claim 8, wherein the obtaining of the indoor map information includes:
obtaining indoor map information on a floor of the building in which the vehicle is located, when the floor of the building in which the vehicle is located is confirmed based on the analyzed location of the vehicle.

10. A navigation device comprising:
a driving information collection unit configured to collect driving information of a vehicle through an on board diagnosis (OBD) scanner of the vehicle;
a terrain information collection unit configured to collect terrain information on a topographic feature located around the vehicle; and
a vehicle location analysis unit configured to analyze a location of the vehicle based on the driving information and the terrain information when the terrain information is collected.

11. The navigation device of claim 10, wherein the terrain information collection unit collects terrain information on a topographic feature recognized by at least one of a short-distance communication terminal, a camera, a sensor, a suspension, a black box, and a barcode reader that are mounted on the vehicle.

12. The navigation device of claim 10, wherein the vehicle location analysis unit sets the location of the vehicle analyzed through the terrain information as a reference point, and analyzes the location of the vehicle based on the reference point and the driving information.

13. The navigation device of claim 12, wherein the vehicle location analysis unit sets a location of a point selected through user input as a reference point when the terrain information is not collected, and analyzes the location of the vehicle based on the reference point and the driving information.

14. The navigation device of claim 12, wherein the vehicle location analysis unit sets the location of the vehicle analyzed through the GPS signal as a reference point when the terrain information is not collected, and analyzes the location of the vehicle based on the reference point and the driving information.

15. The navigation device of claim 14, wherein the vehicle location analysis unit sets a location of the vehicle analyzed through the GPS signal as the reference point when the terrain information is not additionally collected while the vehicle moves more than a preset reference distance from a point corresponding to a recently collected terrain information.

16. The navigation device of claim 15, further comprising:
a reference distance setting unit configured to set the reference distance based on at least one of a vehicle average speed, a driving habit, and a road condition.

17. The navigation device of claim 10, further comprising:
a map information acquisition unit configured to acquire indoor map information on the building, when the vehicle is detected as having entered the building based on the analyzed location of the vehicle.

18. The navigation device of claim 17, wherein the map information acquisition unit obtains indoor map information on a floor of the building in which the vehicle is located, when the floor of the building in which the vehicle is located is confirmed based on the analyzed location of the vehicle.
